(19) United States
(12) Patent Application Publication
(10) Pub. No.: US 2015/0360187 A1
(43) Pub. Date: Dec. 17, 2015

(54) MIXER FOR SHAVING CREAM DISPENSER

(71) Applicant: Mark Varone, Elsmere, DE (US)

(72) Inventor: Mark Varone, Elsmere, DE (US)

(21) Appl. No.: 14/729,307

(22) Filed: Jun. 3, 2015

Related U.S. Application Data
(60) Provisional application No. 62/011,813, filed on Jun. 13, 2014.

(51) Int. Cl. B01F 15/00; B01F 3/08; B01F 7/00

(52) U.S. Cl. CPC B01F 15/00506; B01F 7/00; B01F 3/0853; B01F 15/00538

(57) ABSTRACT

A mixer for a shaving cream dispenser is disclosed which improves dispersion of shaving cream within the dispenser before it is dispensed as a lather.

### CROSS-REFERENCE TO RELATED APPLICATION

This application claims the benefit, pursuant to 34 U.S.C. §119(e) of U.S. Provisional Application No. 62/001,813, filed Jun. 13, 2014. The entirety of the foregoing application is incorporated herein by reference.

### BACKGROUND OF THE INVENTION

Shaving cream dispensers are used in many barbershops. The hot lather dispensed from such machines is incomparable in its refreshing feel on the face. Typical of such dispensers is that sold by Campbell under the LATHER KING trademark (See, FIG. 1).

Such dispensers typically have a container for water in the top of the dispenser and an electric resistance coil in the container for heating the water. A shaving cream solution is then added to the hot water. The combination of hot water and shaving cream is then dispensed under pressure to create a refreshing shaving lather.

### SUMMARY OF THE INVENTION

One drawback of such dispensers is, that over time, the shaving cream settles out in the container. As it settles it lowers the amount of shaving cream dispensed as a lather. In addition the settling shaving cream congeals in the bottom of the container and has to be washed out each day. The congealed shaving cream can also cause overheating of the lather, which can cause it to “burn out” and/or scald customers who are being shaved. These conditions adversely affect the lather produced and increase the labor needed to maintain the lather dispenser, or worse.

To overcome these deficiencies in current lather dispensers, applicant has added a unique, yet simple, mixer to the container that effectively keeps the shaving cream in suspension within the container until needed. The mixer blade within the container can be manually rotated by a knob extending from the container, or if desired, be motor driven. When the mixer is rotated, either manually or by motor, the mixer stirs up any shaving cream that has settled out in the container. It thus returns to a uniform solution in the container and when dispensed, emits a refreshing lather all day.

### DESCRIPTION OF THE FIGURES

FIG. 1 is an exterior plan view of a typical shaving cream dispenser for hot lather.

FIG. 2 is a perspective view of the mixer of this invention.

FIG. 3 is a plan view of the mixer components, as dissembled.

### DETAILED DESCRIPTION OF THE INVENTION

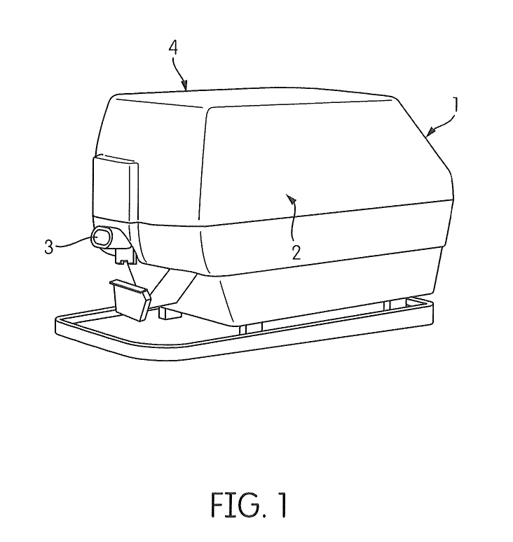

A typical shaving cream dispenser 1 is illustrated in FIG. 1. It typically has an internal reservoir 2 for mixing the ingredients of a hot shaving cream lather. Those ingredients are, basically water and a liquid shaving cream. An internal heater (not illustrated) raises the water to a desired temperature for use on a customer's face. The mixture of warm water and shaving cream is then dispensed under pressure through outlet 3 (FIG. 1) so that it expands as it exits dispenser 1. The warm, expanded material is a foam that is then applied to a customer's face.

The ingredients, water and shaving cream, are typically added to existing shaving cream dispenser 1 through a lid 4 that covers the reservoir 2 (See FIG. 1). However, those ingredients can stay stagnant in the reservoir for an extended period, sometimes hours, between shaves. It has been found that during such lulls in the use of dispenser 1 that the shaving cream tends to settle to the bottom of the reservoir forming a sludge that does not readily disperse. This results in at least two adverse conditions: (a) the dispensed lather is not as stiff and consistent as needed for a good shave and (b) the heavier components of the shaving cream settle to the bottom of the reservoir and are difficult to remove from the reservoir. Other problems associated with lack of a mixer in reservoir include: clogging; heating element burn out due to overheating from the buildup of shaving cream sediments on bottom of reservoir; temperature variation for the cream which can result in burning the barber or client; and difficulty in providing the closest shave possible.

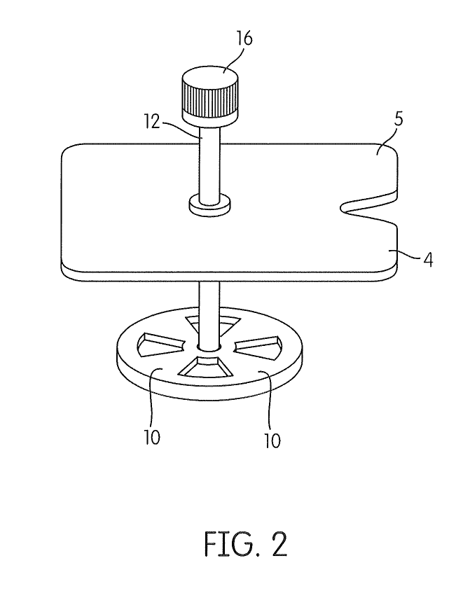

To alleviate these problems this invention provides a unique mixer assembly 5 to stir the contents of reservoir 2 before dispensing any shaving cream (See FIG. 2).

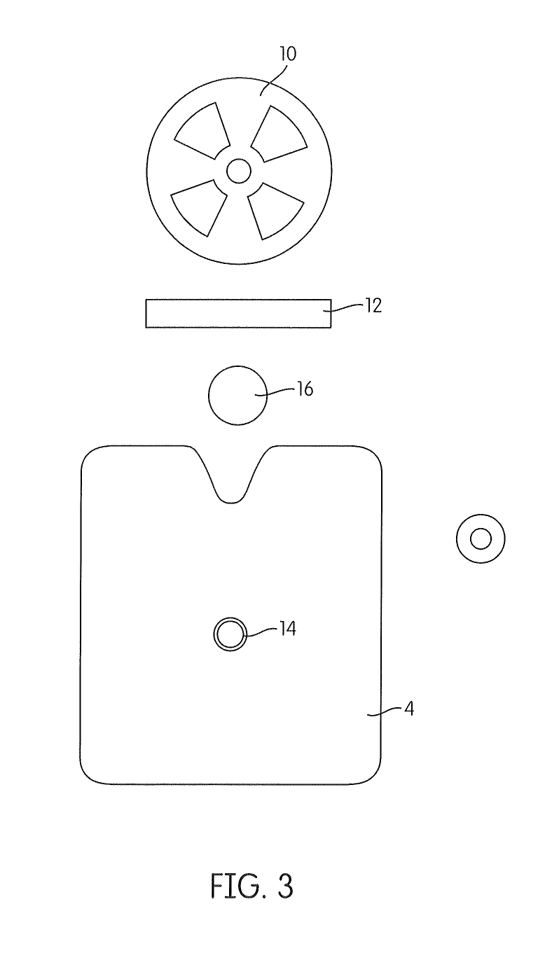

The mixer 5 in one embodiment, comprises a propeller type series of blades 10 radially arranged about a central shaft 12 (See FIGS. 2 and 3). The shaft 12 is journaled for easy manual rotation in a journaled aperture 14 in the lid 4 of the reservoir 2 as illustrated in FIGS. 2 and 3. Other suitable mixing means such as a motor can be used as long as they create sufficient turbulence to stir settled shaving cream in the dispenser 1 and return it to suspension within the reservoir 2.

A knob 16 attached to the shaft 12 can be easily twisted and turned a few times before each shave to redistribute the shaving cream in the reservoir 2 thereby eliminating the problems noted above. Approximate relative dimensions of the various components disclosed in the illustrated embodiment are shown in FIG. 3.

I claim:

1. A mixer for a shaving cream dispenser, which dispenser includes a container for receipt of water and a shaving cream solution, wherein the mixer comprises
a shaft extending through an outer surface of the container, into the interior of the container;
a means for facilitating rotation of the shaft at one end of the shaft;
a mixing device within the container attached to an opposite end of the rotatable shaft and rotatable within the interior of the container;
wherein rotation of the shaft mixes the water and shaving cream within the container to improve the foaming shaving cream discharged from the dispenser.

2. The mixer of claim 1 wherein the means for rotation of the shaft includes a knob to be hand actuated by a user of the mixer.

3. The mixer of claim 1 wherein the means for rotation of the shaft includes a motor.

4. The mixer of claim 1 wherein the mixing device comprises multiple blades radiating from the shaft.
